(19) United States
(12) Patent Application Publication
(10) Pub. No.: US 2024/0154224 A1
(43) Pub. Date: May 9, 2024

(54) SOLID-STATE BATTERY PRISMATIC CELL STACK

(71) Applicant: Mercedes-Benz Group AG, Stuttgart (DE)

(72) Inventor: Tobias Glossmann, Birmingham, MI (US)

(21) Appl. No.: 17/981,550

(22) Filed: Nov. 7, 2022

(51) Int. Cl. H01M 50/209; H01M 50/15; H01M 50/176

(52) U.S. Cl. CPC H01M 50/209; H01M 50/15; H01M 50/176

(57) ABSTRACT

Subject matter herein relates to a solid-state battery (SSB) prismatic cell stack, an energy storage system that may utilize a SSB prismatic cell stack, and a method of manufacturing a SSB prismatic cell stack. In an embodiment, a SSB prismatic cell stack may include a substantially rigid casing including a top cover and relatively narrow opposing sides in relation to relatively broad opposing faces; a plurality of cells stacked within the substantially rigid casing, the plurality of cells having relatively broad opposing faces and relatively narrow opposing sides; a compliant material disposed between faces of adjacent cells of the plurality of cell to accommodate an increase of up to 20 percent displacement of a surface of the relatively broad opposing faces of the plurality of cells and a potting material to be placed proximate to one or more of the relatively narrow opposing sides of the plurality of cells.

### TECHNICAL FIELD

The present disclosure relates generally to energy storage devices and, more particularly, to solid-state battery (SSB) prismatic cell stacks, such as for use in or with electrified vehicles, for example.

### BACKGROUND

As electrified vehicles, such as, for example, fully or partially electrically powered automobiles, delivery trucks, cargo vehicles, mopeds, bikes, etc., become increasingly popular, utilization of on-board batteries for such vehicles also increases. In addition, electrified vehicles may also include a battery management system (BMS), such as to facilitate and/or support safe battery operation, for example, via battery monitoring, balancing, etc., optimizing delivery of electric power to the vehicle's drive systems, infotainment systems, or the like. Having a properly designed battery and/or a BMS may extend battery life, maximize battery performance, improve battery safety, optimize power delivery, etc., which in turn may improve driver and passenger comfort, extend a driving range of an electrified vehicle, reduce its overall maintenance and/or operating costs, or the like.

Typically, although not necessarily, on-board batteries may include a relatively large number of individual energy storage cells that may be connected or coupled in series or parallel, such as to achieve requisite voltage and/or current. Depending on an application, manufacturer, electrified vehicle, etc., cylindrical, prismatic, or pouch energy storage cells may, for example, be used. In some instances, energy storage cells and/or sub-cells may, for example, be “stacked” or arranged to form one or more so-called “cell stacks,” which may subsequently form or include an on-board battery. At times, such an arrangement, if designed properly, may allow more effective and/or more efficient battery production, installation, scaling up, management, maintenance, replacement, recycling, or the like. On-board batteries may include, for example, solid-state batteries (SSBs) with a solid electrolyte layer as well as batteries or storage cells employing liquid electrolytes, which may also depend on an application, manufacturer, electrified vehicle, or the like.

Due, at least in part, to a mobile nature of these applications, a size and weight of an on-board battery, among other aspects, may become increasingly important. As such, in designing these or like batteries, a premium may, for example, be placed on a more effective use of battery space, such as to allow for on-boarding of numerous other devices, systems, equipment, or the like. In addition, so-called “energy density” or energy per unit of weight (or volume) may also become an important design factor that may contribute, at least in part, to reducing battery space, for example, while improving efficiency and/or range of electrified vehicles. While utilization of liquid electrolyte batteries in electrified vehicles may have been more mainstream so far, a viable alternative to these technologies may include, for example, solid-state batteries or SSBs. For example, it has been observed that, in some instances, SSBs may have lower flammability, improved cycle characteristics, better electrochemical stability, as well as higher energy density, among other aspects, compared to liquid electrolyte batteries.

However, SSBs may often require a relatively high cell stack pressure, such as in order to achieve a proper contact between layers such as the current collector and electrode layers, for example, to control cell morphology, etc. Also, in some instances, SSBs may “breathe,” such as due to cell material expanding over a charge-discharge cycle, for example, by a large percentage relative to individual cell thickness. As such, at times, it may be difficult to achieve a homogenous or otherwise suitable cell stack pressure without significant reduction of packaging efficiency. In addition, to maintain mechanical properties of a battery pack (e.g., a structural battery, etc.), solid cell casings may important or even be critical, for example, and casing materials may need to fulfill multiple purposes, which may also introduce additional complexity. Accordingly, how to design and/or implement an on-board SSB, such as without utilization of excessive casing materials, for example, while achieving a homogenous or otherwise suitable cell stack pressure continues to be an area of development.

### SUMMARY

One general aspect includes a solid-state battery prismatic cell stack, including a substantially rigid casing including relatively narrow opposing sides and top cover in relation to relatively broad opposing faces. The solid-state battery prismatic cell stack may include a plurality of cells stacked within the substantially rigid casing, the plurality of cells having relatively broad opposing faces and relatively narrow opposing sides, the relatively narrow opposing sides of the plurality of cells may abut a first side (e.g., a bottom) of the substantially rigid casing. The solid-state battery prismatic cell stack may also include a compliant material disposed between faces of adjacent cells of the plurality of cells, and the compliant material being disposed may accommodate a displacement of a surface of the relatively broad opposing faces of the plurality of cells up to 20 percent. The solid-state battery prismatic cell stack may further include a potting material to be placed into contact with one or more of the relatively narrow opposing sides of the plurality of cells, e.g., at the bottom of the substantially rigid casing.

In particular embodiments, the substantially rigid casing may include a wall thickness dimension of between about 0.3 millimeter and 1.0 millimeter. In particular embodiments, the substantially rigid casing may include a width dimension of between about 15 millimeters and about 175 millimeters. In certain embodiments, the substantially rigid casing may include a width dimension of between about 40 millimeters and about 60 millimeters. In particular embodiments, the substantially rigid casing may include a length dimension of the first side that is between about 1.5 times and about 10 times the width dimension of the substantially rigid casing. In particular embodiments, the substantially rigid casing may include a length dimension that is between about 1.5 times and about 10 times a height dimension of the substantially rigid casing. In particular embodiments, the substantially rigid casing may include a height dimension of between about 40 millimeters and about 160 millimeters. In particular embodiments, the substantially rigid casing may maintain a stack pressure on the plurality of cells of between about 0.4 megapascals and about 4.5 megapascals. In some embodiments, the plurality of cells may be produced utilizing one or more solid-state compounds for a low-voltage application. In another embodiment, the cells correspond to solid-state low-voltage cells. In particular embodiments, the prismatic cell stack may include a shape that corresponds to that of a right rectangular prism.

Another general aspect includes an energy storage system for an electrified vehicle, including one or more substantially rigid casings for one or more prismatic cell stacks. The energy storage system may include a plurality of cells and/or sub-cells. For example, the energy storage system may include a plurality of solid-state battery prismatic cells within the substantially rigid casings, the plurality of solid-state battery prismatic cells having broad opposing faces in relation to opposing sides of the cells, the opposing sides of the cells in contact with the broadest side of the substantially rigid casings. In some embodiments, the solid-state battery prismatic cell stacks may include a compliant material disposed between faces of adjacent cells of the plurality of cells, and the compliant material being disposed may accommodate a displacement of a surface of the relatively broad opposing faces of the plurality of cells up to 20 percent. For example, the compliant material may include a deformable material disposed between adjacent cells of the plurality of cells. The deformable material may accommodate a distortion or displacement of a surface of the relatively broad opposing faces of the plurality of cells. In particular embodiments, the energy storage system may also include a potting material to fasten the plurality of cells to the substantially rigid casings.

In particular embodiments, the displacement of the surface of the relatively broad opposing faces occurs responsive to an increase in a state-of-charge of an energy storage device of the plurality of cells. In particular embodiments, the displacement of the surface of the broad opposing faces includes between about 5.0 percent and about 20.0 percent. In particular embodiments, the energy storage system may further include a battery management system or a storage cell management system, coupled to one or more of the plurality of cells, to compute impedance of one or more of the plurality of the cells. The energy storage system may also initiate operation of at least one of the one or more of the plurality of cells at an increased state-of-charge. In particular embodiments, the storage cell management system may operate to compute the impedance of the one or more of the plurality of the cells responsive to aging of the plurality of the cells. In particular embodiments, the storage cell management system is to initiate operation of at least one of the one or more of the plurality of cells at an increased state-of-charge responsive to programming instructions of the storage cell management system to maintain a stack pressure on the plurality of cells of between about 0.4 megapascals and about 4.5 megapascals.

Another general aspect includes a method for manufacturing a solid-state battery (SSB) prismatic cell stack. The method includes stacking a first cell, the first cell including an electrode and a solid electrolyte, the first cell being oriented so as to align a relatively broad face of the first cell substantially parallel to a relatively narrow face of a substantially rigid casing. The method also includes depositing a compliant polyurethane material proximate to the stacked first cell. The method also includes stacking a second cell, in an orientation similar to that of the stacked first cell, proximate the compliant polyurethane material. The method also includes depositing the compliant polyurethane material proximate to the stacked second cell. The method also includes stacking a third cell in an orientation similar to that of the stacked first cell and the stacked second cell.

In particular embodiments, the compliant polyurethane material includes at least a substantial percentage of polyurethane foam. In particular embodiments, the method further includes depositing a potting material at a first inside surface of a substantially rigid casing. In particular embodiments, the method further includes positioning the SSB prismatic cell stack inside the substantially rigid casing, in which the SSB prismatic cell stack is proximate with the potting material. In particular embodiments, the method may further include depositing a polymer-based gap filler to a second inside surface and a third inside surface of the substantially rigid casing. In particular embodiments, the method may additionally include depositing an elastic filler in the substantially rigid casing, in which the SSB prismatic cell stack is coupled to the elastic filler. In particular embodiments, the first inside surface corresponds to the bottom inside surface of the substantially rigid casing. In particular embodiments, the second inside surface and the third inside surface correspond to first and second opposing sides of the substantially rigid casing, the first and second opposing sides being relatively narrow in relation to third and fourth opposing sides at right angles to the first and second opposing sides. In particular embodiments, the method may additionally include configuring a positive terminal connection and a negative terminal connection for the SSB prismatic cell stack, in which the positive terminal connection is to couple positive current collectors for the first cell, the second cell, and the third cell, and in which the negative terminal connection is to couple negative current collectors for the first cell, the second cell, and the third cell.

Claimed subject matter is intended to embrace some or all of the above-described actions in any order. Further, claimed subject matter is intended to embrace methods including additional actions other than those described.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, claimed subject matter may be best understood by reference to the following detailed description if read in light of the accompanying drawings in which:

FIG. 1 is a schematic diagram depicting a portion of an example energy storage and distribution system for use in an electrified vehicle, according to an embodiment.

FIGS. 2A and 2B are schematic diagrams to represent an energy storage device utilizing a prismatic cell stack, according to an embodiment.

FIGS. 3A and 3B are schematic diagrams to represent additional details of an energy storage device utilizing a prismatic cell stack, according to an embodiment.

FIGS. 4A-4D are schematic diagrams to represent stack pressure applied to energy storage cells of an energy storage device utilizing a prismatic cell stack, according to an embodiment.

FIG. 5 is a schematic diagram showing a battery management system interfaced to a number of low-voltage storages, according to an embodiment.

FIG. 6 is a schematic block diagram illustrating an example computing system environment, according to an embodiment.

FIG. 7 is a flow chart showing a method to manufacture a SSB prismatic cell stack, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, the particular context of description and/or usage provides helpful guidance regarding inferences to be drawn.

As alluded to previously, as electrified vehicles become increasingly popular, utilization of on-board batteries also steadily increases. In this context, an “electrified vehicle” should be interpreted broadly and refers to a vehicle that utilizes electric power at varying stages of powering its drivetrain, such as instead of or in addition to powering its peripherals and/or accessories (e.g., power windows, sun roof, radio, seats heating, etc.). Thus, depending on an implementation, an electrified vehicle may include, for example, a partially electric vehicle (e.g., a hybrid, etc.), a fully electric vehicle (e.g., an EV, etc.), or any suitable combination thereof, such as if applicable and/or appropriate.

As was also indicated, an electrified vehicle may also include an on-board battery management system (BMS), such as to facilitate and/or support safe battery operation, among other aspects, for example, by keeping the battery within its safe operating area (SOA). Briefly, for purposes of explanation, a BMS may, for example, monitor a battery's state of charge (SOC), state of health (SOH), and/or other aspects, may implement cell balancing during charge and/or discharge cycles, may facilitate and/or support storage and/or release of energy, or the like. For example, as will be seen, in at least one implementation, a suitable compliant material may be disposed between individual energy storage cells of a cell stack, such as to at least partially absorb variations in cell expansion during battery charging and discharging. Here, a BMS may, for example, detect a loss of cell stack pressure (e.g., by calculating cell impedance from voltage, current, and temperature, etc.), which may be due, at least in part, to aging or degradation of a compliant material, for example, and may adjust battery operation at a higher SOC in order to maintain a suitable stack pressure. Particular example implementations of a cell stack, compliant material, BMS, etc. will be described with particularity in greater detail below.

Within an energy storage device, which, in this context, refers to a device including a plurality of individual energy storage cells, a compliant material may be disposed between adjacent cells of each of the plurality of individual storage cells. Thus, responsive to an increase in volume of one or more of the individual energy storage cells, the compliant material may be permitted to deform, thereby accommodating the increase in volume. However, although the compliant material may deform responsive to an increase in volume of an individual energy storage cell, the compliant material, which may include a polyurethane material, may include substantial rigidity so as to maintain contact pressure with the relatively broad faces of the individual storage cells. Thus, in particular embodiments, regardless of the expansion state of individual energy storage cells, the combination of the substantially rigid casing and the compliant material between the individual storage cells may operate to maintain stack pressure on the plurality of individual storage cells. In this context the term “compliant material” refers to any material, which may include polyurethane, for example, suitable for use as a deformable filling material between adjacent lithium-ion (e.g., solid-state lithium-ion) energy storage cells of an energy storage device. In addition, although the compliant material may be deformable, the compliant material may continue to transmit stack pressure to an energy storage cell regardless, for example, of the expansion of one or more of adjacent energy stored cells.

In the context of the present disclosure, a “substantially rigid” material refers to a property of bending or deformation of the material by only a negligible amount in response to an applied force. Thus, for example, a substantially rigid casing refers to a casing or housing that does not deform by less than, for example, 2.0 millimeter. Further in the context of the present disclosure, a “compliant” material refers to a property of the material to bend or to deform in response to an applied force.

As was also indicated, typically, although not necessarily, on-board batteries may include, for example, a relatively large number of individual energy storage cells that may be connected or coupled in series or parallel, such as to achieve requisite voltage and/or current. Depending on an application, manufacturer, vehicle, etc., cylindrical, prismatic, and/or pouch battery cells may, for example, be utilized, in whole or in part. In some instances, battery cells may, for example, be “stacked” or arranged to form one or more “cell stacks,” which may subsequently form or include an on-board battery. As will also be seen, one or more cell stack designs, such as implemented via one or more approaches and/or techniques discussed herein, may provide advantages, which may include, for example, more effective and/or more efficient battery production, installation, scaling up, management, maintenance, replacement, recycling, or the like. It should be noted that the terms “cell stack,” “stack,” or the like may be used interchangeably herein, such as for ease of discussion. In addition, it should also be appreciated that the terms “energy storage cells,” “battery cells,” “cells,” or the like may also be used interchangeably herein. It should also be appreciated that the terms “casing,” “housing,” or the like, may also be used interchangeably herein.

Continuing with the above discussion, as was also indicated, in some instances, a viable alternative to liquid electrolyte batteries may include, for example, SSBs that utilize solid electrodes and electrolytes rather than liquid or polymer electrolytes. For example, benefits of SSBs may include lower flammability, improved cycle characteristics, better electrochemical stability, as well as higher energy density, among other aspects. As such, in some instances, SSBs may, for example, be capable of delivering improved performance at a comparatively lower cost. However, SSBs may often require a relatively high cell stack pressure, such as in order to achieve a proper contact between electrode layers, for example, to control cell morphology, or the like. Also, SSBs may “breathe,” such as due to cell material expanding over a charge-discharge cycle, for example, by a large percentage relative to cell thickness. As such, at times, it may be difficult to achieve a homogenous or otherwise suitable cell stack pressure, such as without significant reduction of packaging efficiency, for example. In addition, to maintain mechanical properties of a battery pack (e.g., a structural battery, etc.), solid cell casings may be important or, at times, even critical, for example, and casing materials may need to fulfill multiple purposes.

In some instances, to address these or like issues, certain SSBs may be assembled with one or more cells and/or sub-cells having their own casing such as hard-case or pouch-cell casings, for example, such as in an attempt to accommodate stack pressure as well as cell expansion. In these or like instances, however, a mechanical structure of a battery pack may have to be constructed at the expense of additional stiff members, such as in an attempt to maintain sufficient rigidity of the pack. Furthermore, here, many tabs may have to be connected or coupled outside of an individual cell casing and/or a cell stack casing, for example, or relatively large area electrodes may have to be stacked, which may introduce additional or otherwise undesired complexity to a SSB design. At times, this may also result in a lower production yield, for example, and may increase difficulty in achieving homogenous or otherwise suitable stack pressure, which may also be important or even critical to a number of SSB designs. Accordingly, it may be desirable to design and/or implement one or more on-board SSBs, such as without utilization of excessive casing materials, for example, while achieving a homogenous or otherwise suitable cell stack pressure, among other benefits, as will also be seen.

Thus, as will be described in greater detail below, in an implementation, a number of individual SSB prismatic energy storage cells (e.g., without casings, etc.) may, for example, be stacked and then connected or coupled electrically in parallel fashion, although claimed subject matter is not so limited. For example, in some instances, such as if individual cell balancing and/or monitoring by an associated BMS may not be required or otherwise useful, individual cells may be connected or coupled electrically in series, just to illustrate another possible implementation. Briefly, for purposes of explanation, a “prismatic” cell refers to an energy storage cell whose chemistry is enclosed in a rigid prismatically-shaped (e.g., typically, rectangular, etc.) casing. Here, to facilitate and/or support one or more implementations discussed herein, any suitable prismatic cells (e.g., currently existing, developed in the future, etc.), such as, for example, cells with internally stacked, rolled, flattened, etc. electrodes (e.g., anode, separator, cathode) or the like, or any suitable variations thereof, may be used, in whole or in part, or otherwise considered. Prismatic cells are generally known and need not be described herein in greater detail.

As also discussed below, a cell stack may then be integrated in a particular cell casing, such as, for example, a rectangular casing constructed using a structurally beneficial, but chemically and/or electro-chemically compatible material with a suitable heat conductivity (e.g., metal, etc.), just to illustrate one possible implementation. In some instances, the casing may be implemented with varying thicknesses throughout its body, which may depend, at least in part, on pressure requirement of individual cells, casing material, or the like. As one example, as will be seen, a casing may be advantageously designed, such that a thickness at smaller opposing end plates or walls of the casing may be different from a thickness of its relatively longer side walls and may also be different from a thickness of its bottom wall. In some instances, this may provide benefits, such as, for example, improve pressure uniformity (e.g., in the direction of cell stacking, etc.), may facilitate and/or support suitable (e.g., peripheral, etc.) stack pressure, may provide sufficient structure to a cell stack, among other benefits. Furthermore, here, a homogenous or otherwise suitable cell stack pressure may be achieved, such as without utilization of excessive casing materials, as was indicated, for example, and respective electrode areas may be maintained at a manageable or otherwise suitable size. At times, a casing may also serve as a structural component for a more effective and/or more efficient battery pack design, for example, and may allow cells to connect thermally to the casing by using the casing as one terminal. This may, for example, allow current collectors of a particular electrical terminal to connect directly or otherwise suitably to the casing, as will also be seen.

Additionally, a cell and/or sub-cell may then be integrated into a particular cell casing, such as, for example, a rectangular casing constructed using a structurally beneficial, but chemically and/or electro-chemically compatible material with a suitable heat conductivity (e.g., metal, etc.), just to illustrate one possible implementation. In some instances, the casing may be implemented with varying thicknesses throughout its body, which may depend, at least in part, on a pressure requirement of individual cells, casing material, or the like. In an example, as will be seen, a casing may be advantageously designed, such that a thickness at smaller (e.g., relatively narrow) opposing end plates (i.e., sides) or walls of the casing may be different from a thickness of its relatively longer (e.g. relatively broad) side walls and may also be different from a thickness of its bottom wall. In some instances, this may provide benefits, such as, for example, improve pressure uniformity (e.g., in the direction of cell stacking, etc.), may facilitate and/or support suitable (e.g., peripheral, etc.) stack pressure, may provide sufficient structure to a cell stack, among other benefits. Furthermore, here, a homogenous or otherwise suitable cell stack pressure may be achieved, such as without utilization of excessive casing materials, as was indicated, for example, and respective electrode areas may be maintained at a manageable or otherwise suitable size. At times, a casing may also serve as a structural component for a more effective and/or more efficient battery pack design, for example, and may allow cells to couple thermally to the casing by using the casing as one terminal. This may, for example, allow current collectors of a particular electrical terminal to connect directly or otherwise suitably to the casing, as will also be seen.

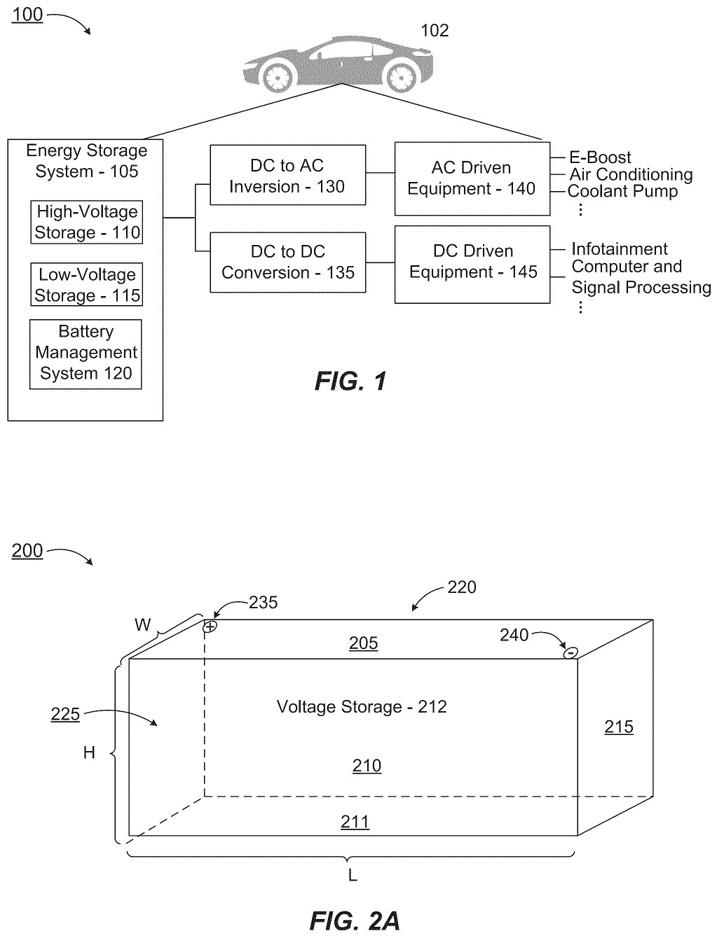

FIG. 1 is a schematic diagram illustrating features associated with an example energy storage and distribution system that may be utilized, at least in part, in or with an electrified vehicle, referenced generally at 102, according to an embodiment 100. In FIG. 1, electrified vehicle 102 may include, for example, a variety of additional systems, subsystems, modules, assemblies, and/or components, which bring about various driving, handling, communications, lighting, entertainment, heating, air conditioning, and other features of electrified vehicle 102. However, for the sake of simplicity, only a portion of the energy storage and distribution system utilized by electrified vehicle 102 is shown in FIG. 1. As was indicated, it should be noted that electrified vehicle 102 may correspond to any type of vehicle, such as an electrified automobile, a hybrid automobile, an electrified delivery vehicle, an electrified cargo vehicle, and so forth, and claimed subject matter is not limited in this respect.

In the embodiment of FIG. 1, energy storage system 105 may include high-voltage storage 110 such as high-voltage batteries, which may include one or more low-voltage storage devices, such as low-voltage batteries, etc., that operate to convert stored chemical energy to an electric current having a voltage of between, for example, approximately 12 Volts and approximately 60 Volts, such as 18 Volts, 24 Volts, 28 Volts, 32 Volts, 36 Volts, 48 Volts, and so forth. Energy storage system 105 may additionally include low-voltage storage 115, which may include one or more energy storage elements such as batteries that operate to convert stored chemical energy to an electric current having a voltage of, for example, between 9 Volts and 14 Volts, such as a nominal voltage of 12 Volts. Energy storage system 105 may additionally include other energy storage elements, such as storage elements to provide backup and/or emergency power, for example.

In particular embodiments, high-voltage storage 110 and low-voltage storage 115 as part of an energy storage system 105 having a prismatic shape may be monitored by, for example, a battery management system 120. In one embodiment, a battery management system 120 may include one or more processors coupled to at least one non-transitory memory device, which may operate to measure an impedance presented by a series or parallel arrangement of energy storage cells and/or sub-cells of an energy storage system 105. In addition, responsive to detecting an increase in impedance presented by one or more energy storage cells and/or sub-cells (such as beyond a threshold impedance), the battery management system 120 may permit a SOC of one or more energy storage cells and/or sub-cells to be increased relative to other energy storage cells and/or sub-cells of the energy storage system 105. By way of such an increase in the state-of-charge of one or more energy cells and/or sub-cells, the battery management system 120 may permit the one or more energy cells to increase in volume, thereby increasing stack pressure(s) applied to, for example, all energy storage cells and/or sub-cells of the energy storage system 105. By way of such increasing of stack pressure, or at least maintaining minimal stack pressure, a battery management system 120 may compensate for aging of energy storage cells and/or sub-cells. Such compensation may enhance the usable life of energy storage devices of energy storage system 105 of, for example, an electrified vehicle 102.

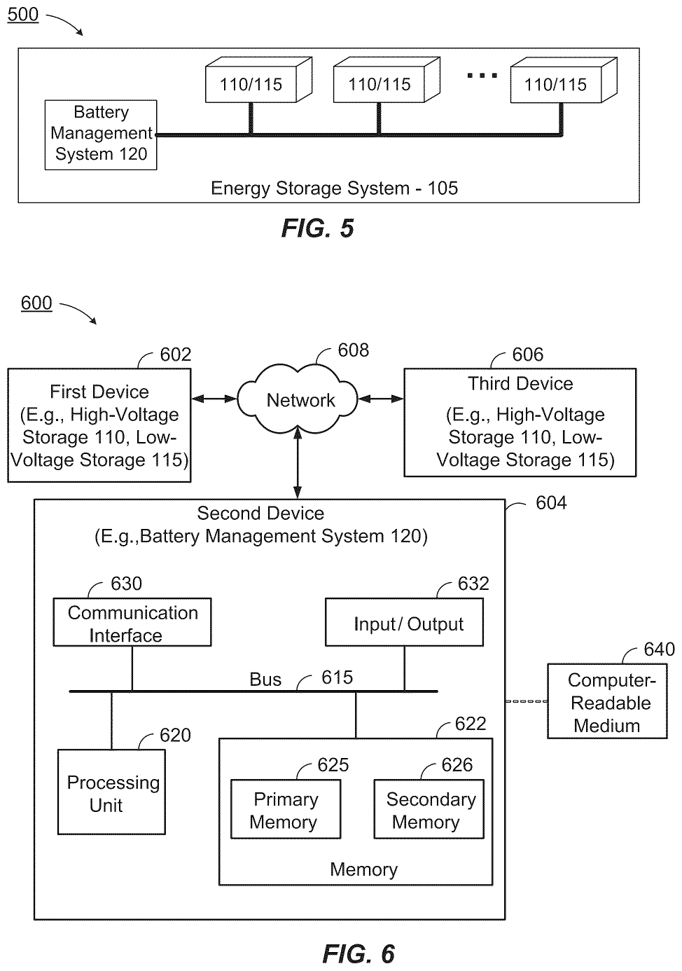

A battery management system 120, such as that described with respect to FIG. 5, may interface with a number of voltage storage devices, such as high-voltage storage 110 and low-voltage storage 115 (of FIG. 1). In particular embodiments, battery management system 120 may additionally be coupled to one or more systems in the electrified vehicle 102 such as the power conditioning modules, such as, for example, DC to AC inversion 130 and DC to DC conversion 135, and claim subject matter is not limited in this respect. In the embodiment of FIG. 5, battery management system 120 may operate to determine the electrical parameters of energy storage elements such as those of energy storage system 105. In addition, battery management system 120 may operate to balance the voltage of, and/or current conduction from, energy storage system 105. For example, responsive to battery management system 120 detecting higher internal resistance of a particular energy storage system 105, the battery management system 120 may permit the particular energy source to be charged to a higher state-of-charge, thereby facilitating or ensuring that the particular voltage storage device, which may include low-voltage storage 115, high-voltage storage 110, etc., is capable of supplying an expected current amount and/or delivering such current at an expected voltage level.

Returning now to FIG. 1, embodiment 100 may also include one or more power conditioning modules, such as, for example, DC to AC inversion 130 and DC to DC conversion 135. DC to DC conversion 135 may operate to provide primary power to DC driven equipment 145, which may include various computers and/or computing equipment, such as infotainment modules, signal processing modules, lighting modules, and so forth. DC to AC inversion 130 may provide primary power to AC driven equipment 140, which may include a booster module that operates to provide energy to an additional motor to occasionally boost performance of electrified vehicle 102. AC driven equipment may additionally include other motorized equipment, such as an air conditioner or coolant pump of electrified vehicle 102. DC to AC inversion 130 and DC to DC conversion 135 may provide energy to additional equipment on board electrified vehicle 102, virtually without limitation.

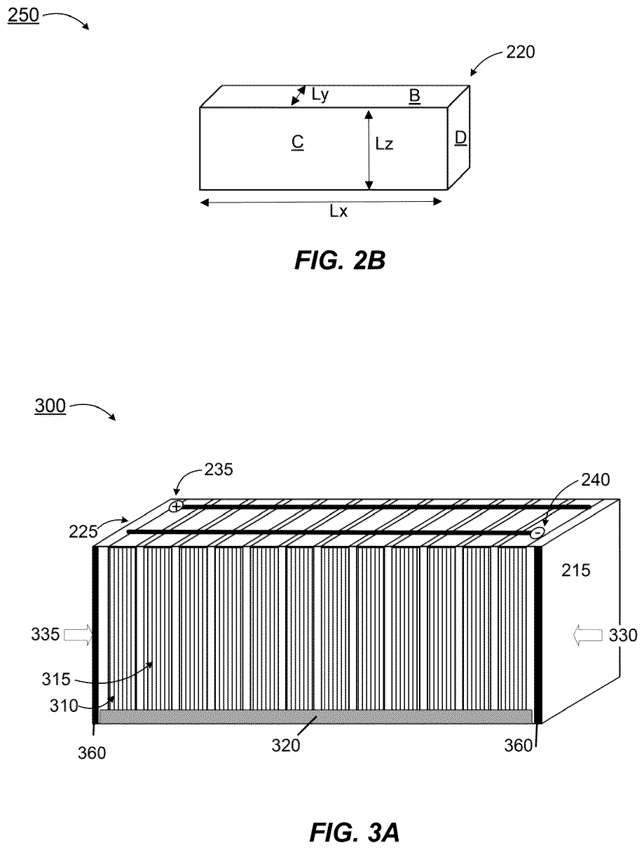

FIG. 2A is a schematic representation of an example SSB, illustrated herein as utilizing a prismatic cell stack, according to an embodiment 200. In the embodiment of FIG. 2A, voltage storage 212 may correspond to a prismatic cell stack, in which the prismatic cell stack may include a plurality of low-voltage storage units 115 of FIG. 1 such as low-voltage solid-state battery cells and/or sub-cells. It should be noted that low-voltage storage 115 may operate as a component of a high-voltage source of energy such as the prismatic cell stack, such as by way of series connection of multiple low-voltage storage devices such as solid-state battery cells, and claimed subject matter is not limited in this respect. Multiple low-voltage SSB cells may be formed to produce a high-voltage storage 110 of FIG. 1 such as utilizing the SSB prismatic cell stacks. Here, low-voltage storage 115, such as a SSB cell may include an anode (e.g. negative electrode), a negative current collector, a solid electrolyte, a cathode (e.g. positive electrode), and a positive current collector.

In certain embodiments, individual energy storage cells, such as individual storage cells of low-voltage storage 115 of prismatic cell stack 200 may be coupled to one another via a series connection or via a parallel connection. In particular embodiments, coupling of low-voltage storage 115 and/or high-voltage storage 110 for energy storage system 105 may occur via a parallel connection achieved via a single bus or terminal connector, which may represent a positive terminal connection and/or a negative terminal connection. In some embodiments, the solid-state prismatic cell stack 200 may be configured to operate utilizing a terminal connection, such as terminal connections 235 and 240, between the SSB cells operating as a positive electrode current collector and a negative electrode current collector. Negative current collectors may be connected or coupled to negative terminal connection 240 and the positive current collectors may be connected or coupled to positive terminal connection 235. Negative terminal connection 240 and positive terminal connection 235 may be connected or coupled to a tab or connection element on the substantially rigid casing 220. In a different embodiment, the SSB prismatic cell stack 200 may also be configured with a tab-less negative electrode. In an example, SSB prismatic cell stack 200 within substantially rigid casing 220 may also be designed with tab-less negative electrode where the negative electrode current collectors are bonded to the casing 220 and the negative terminal connection 240 is also bonded to casing 220.

As is also illustrated, prismatic cell stack 200 may include a substantially rigid casing 220, which may include top surface cover 205, relatively broad face 210, bottom surface 211, and relatively narrow opposing sides 215 and 225 such as end plates for the substantially rigid casing 220. In this context, the terms “relatively narrow” and “relatively broad” refer to relative dimensions, such as length and height, with respect to each other. Thus, for example, relatively narrow opposing sides 215 and 225 are referred to as such in that relatively narrow opposing sides 215 and 225 encompass a width dimension (“W” in FIG. 2A) that is less than the length (“L” in FIG. 2A) encompassed by relatively broad face 210.

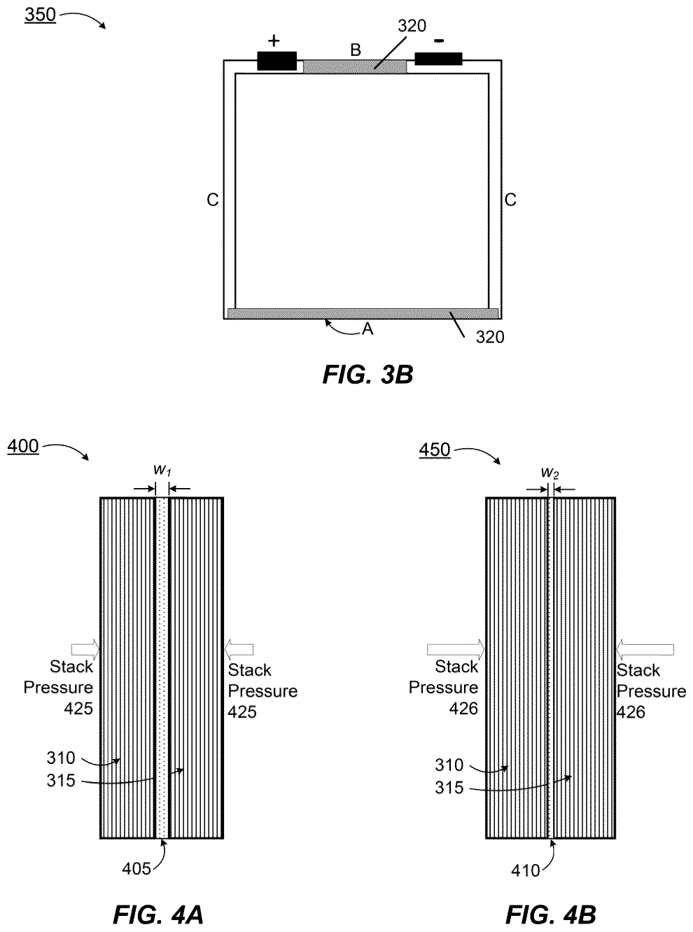

Within substantially rigid casing 220, a plurality of energy storage cells, such as high-voltage cells, low-voltage cells, etc., may be arranged in similar orientations, so as to position relatively broad, opposing faces of individual storage elements in the direction of relatively narrow opposing sides 215 and 225. Accordingly relatively narrow edges of energy storage cells may be arranged side-by-side, so as to abut relatively broad face 210. In some embodiments, energy storage system 105 may include SSB prismatic cell stack 200, which may include one or more cells and/or sub-cells, where the cell stacks may constitute low-voltage storage 115 or high-voltage storage 110 based, at least in part, on a nominal voltage of the one or more cells and/or sub-cells. Particular examples of energy storage cells disposed within substantially rigid casing 220 will be described further in reference to FIGS. 3A and 3B herein.

In the embodiment of FIG. 2A, a substantially rigid casing 220 may include a metallic material, such as stainless steel, for example, having a thickness dimension of between 0.3 millimeters and about 1.0 millimeter. In particular embodiments, substantially rigid casing 220 may include a width (W) dimension of between about 40 millimeters and about 60 millimeters. In a particular embodiment, substantially rigid casing may include a different width (W) dimension, such as a width dimension of between about 15 millimeters and about 175 millimeters. Additionally, substantially rigid casing 220 may include a length dimension (L) that is between about 1.5 and about 10 times the width (W) or the height (H) of substantially rigid casing 220. Thus, in a particular embodiment, substantially rigid casing 220 may include a length (L) dimension that is between 60 millimeters and 600 millimeters. In particular embodiments, the substantially rigid casing 220 of FIG. 2A may include a height dimension (H) that is between about 40 millimeters and about 160 millimeters. It should be noted, however, that claimed subject matter is intended to embrace rigid casings including virtually any length (L) dimensions, height (H) dimensions, and width (W) dimensions.

In reference to FIG. 1, it may be appreciated that in designing battery systems for use with electrified vehicles, in addition to other factors, a premium may be placed on reducing, for example, volume consumed by batteries, so as to ensure that the electrified vehicle maintains ample volume for passengers, cargo, etc. For example, in particular electrified vehicles, batteries and/or other types of chemical energy storage devices may include a cylinder shape, which may be aggregated to form a two-dimensional array of batteries. However, it may be appreciated that a side-by-side arrangement, for example, of cylinder-shaped batteries, may result in wasted volume in between batteries. By some estimates, packing density of cylinder-shaped batteries may give rise to a packing efficiency of perhaps less than 75 percent. Accordingly, for a given volume of cylinder-shaped batteries, up to 25 percent of the volume represents unproductive (e.g., wasted) space. It may be appreciated that such inefficiencies in packing density reduce volume available for passengers, cargo, motors and drive systems, for example, of the electrified vehicle.

In some instances, solid-state storage devices, such as prismatic cell stack 200, or other energy storage devices part of the energy storage system 105, may be fabricated as rectangle-shaped battery cells, which may bring about some improvement in packing density in relation to cylinder-shaped battery cells. However, in certain scenarios, SSB prismatic cell stacks 200 may exhibit a tendency to increase in volume in response to aging of a battery cell as well as to increases in the state-of-charge of the battery cell. Consequently, an array of battery cell stacks may nonetheless increase in volume as a result of gases discharged from a battery cell or perhaps due to other physical phenomena. Accordingly, under certain circumstances, despite fabrication of solid-state batteries to form various shapes, such battery cells may nonetheless be prone to consuming unnecessary volume.

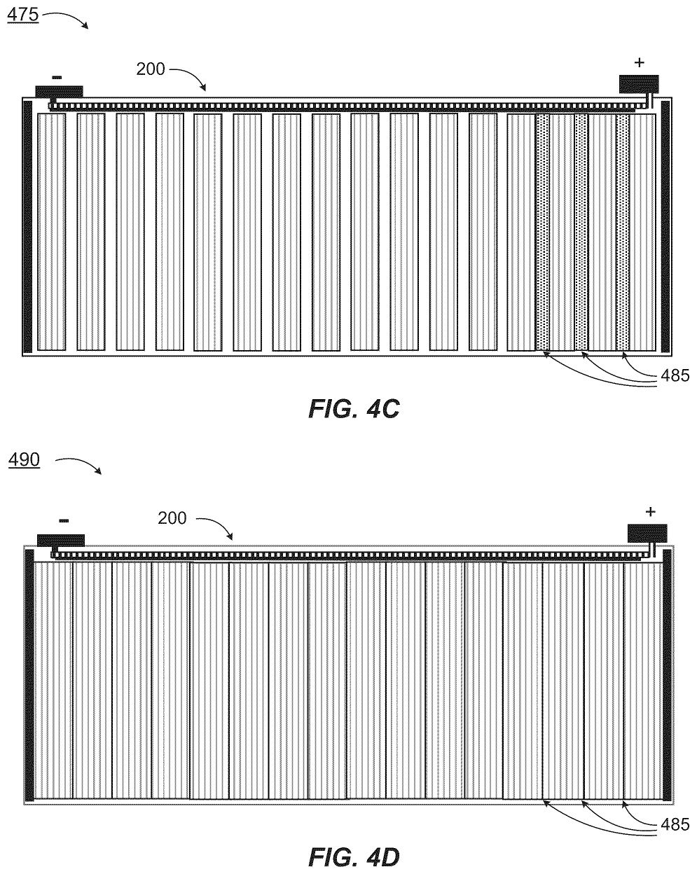

FIG. 2B is schematic representation depicting relative dimensions of an example SSB prismatic cell stack 200, which, in some instances, may correspond to low-voltage storage 115 of FIGS. 1 and 2A, according to an embodiment 250. In embodiment 250, substantially rigid casing 220 may expand minimally relative to any suitable compliant material disposed, for example, between individual storage cells of a voltage storage 212 (e.g., high-voltage storage 110 or low-voltage storage 115 of FIG. 1). Particular examples of a compliant material that may be used herein, in whole or in part, will be discussed in greater detail below, such as with reference to FIGS. 3A, 3B, 4A, 4B, 4C and 4D, for example. In the example of FIG. 2B, which may depict aluminum casing C, having a length Lx, which may correspond to relatively broad face 210 of FIG. 2A, may be designed to carry a tensile load of between 0.5 Megapascals and 4.0 Megapascals from the relatively narrow surface with opposing sides or end plates D of substantially rigid casing 220. In the example of FIG. 2B, the relatively broad face wall thickness C may include, for example, a thickness dimension of about 0.4 millimeter. In other embodiments, the relatively broad face wall thickness C may include a thickness dimension of between about 0.1 millimeters and 0.8 millimeters. Dimension Ly of FIG. 2B, for example, may include about 50 millimeters, which may be independent of the dimension Lz. In the embodiment of FIG. 2B, a stack pressure swing responsive to charging/discharging of the energy storage cell such as prismatic cell stack 200 may change by an amount of about 1.0 megapascal (MPa). In other embodiments, substantially rigid casing 220 may include stainless steel, for example, or may include other suitable metals and/or metal alloys.

In particular embodiments, in response to a need to increase packing density for battery storage cells, as well as to constrain expansion, battery storage cells may be arranged within a substantially rigid casing 220. In particular embodiments, the substantially rigid casing 220 may have a prismatic shape, such as a shape that accords with that of a right rectangular prism, although claimed subject is intended to embrace various prismatic shapes other than those corresponding to a right rectangular prism. Within a substantially rigid casing 220, energy storage cells may be arranged in a manner that positions a relatively broad opposing face of a first battery storage cell with a relatively broad opposing face of a second battery storage cell. Accordingly, via such side-by-side arrangement of energy storage cells, a stacking pressure may be applied to an ensemble of energy storage cells so as to ensure that the battery storage cells of the prismatic cell stack retains an original volume envelope. By ensuring that the prismatic cell stack retains an original volume envelope, a plurality of energy storage devices can be arranged in close proximity to each other. In addition, despite battery aging and varying states-of-charge of individual energy storage cells and/or sub-cells, energy storage devices may maintain original volume envelopes, even after years of service within an electrified vehicle environment.

In particular embodiments, dimension Lx shown in FIG. 2B may include a linear dimension of between about 1.5 and about 10 times the linear dimension of Ly or Lz. In particular embodiments, Lz may include a linear dimension will be between about 50 and about 150 mm. In particular embodiments, Ly may include a linear dimension of between about 20 to about 150 mm.

FIG. 3A is a schematic diagram illustrating features associated with a SSB prismatic cell stack 200, according to an embodiment 300. In the embodiment of FIG. 3A, top surface cover 205 and one side cover for relatively broad face 210 of, for example, the substantially rigid casing 220 of FIG. 2A, have been removed so as to expose a side-by-side arrangement of individual energy storage cells of the SSB prismatic cell stack 200. Accordingly, as shown, the negative current collectors for the negative electrodes may be connected or coupled to a negative terminal connection 240 and the positive current collectors for the positive electrodes may be connected or coupled to a positive terminal connection 235. The terminal connections 235 and 240 are indicated as being interfaced with a plurality of energy storage cells. In some embodiments, the negative terminal connection may be tab-less in which the negative electrode current collectors are bonded to the casing and the negative terminal connection is also connected or coupled to the casing. FIG. 3A shows individual energy storage cells 310 and 315, shown as being adjacent to each other. In the embodiment of FIG. 3A, storage cells 310 and 315 are depicted as being oriented so as to align a relatively broad face of the storage cells substantially parallel to a relatively narrow side of the casing. Thus, it may be appreciated that a relatively narrow side of the individual energy storage cells abut a relatively broad face of the substantially rigid casing 220 of the SSB prismatic cell stack 200.

In particular embodiments, a SSB prismatic cell stack 200, which may include low-voltage storage 115, high-voltage storage 110, or the like, may provide a capability for maintaining static pressure (or static force) in the direction given by arrows 330 and 335 (e.g., in the direction of stacking). In particular embodiments, relatively broad face 210 (e.g., of FIG. 2A, etc.) may exclusively convey a tensile force, thus avoiding a tendency to form a bulge or other type of distention along the surface of relatively broad face 210. Conversely, relatively narrow side 215 of substantially rigid casing 220 may exclusively convey a normal force, which, at least in particular embodiments, may necessitate use of a material having increased thickness in relation to relatively broad face 210. In particular embodiments, relatively narrow side 215 and relatively narrow opposing side 225 provide a compressive force of, for example, between about 0.4 Megapascals and about 4.5 Megapascals. In particular embodiments, such compressive force (or “stack pressure”) brings about optimal storage cell performance even as storage cells age and undergo numerous charge/discharge cycles. Also shown in FIG. 3A is potting material 320, which, in particular embodiments, constrains movement of individual energy storage cells during maximum and minimum expansion of the individual energy storage cells and/or SSB prismatic cell stacks.

FIG. 3B is a schematic diagram to depict potting material added to a portion of voltage storage 212 of FIG. 2A cells in the SSB prismatic cell stack 200, according to an embodiment 350. As shown in FIG. 3B, addition of a potting material 320 (A in FIG. 3B), may be deposited on at least one inside surface within the substantially rigid casing such as the bottom surface 211 and may provide a thermal interface, which may carry heat away from individual stored cells and/or sub-cells that may be included in a SSB prismatic cell stack 200. Potting material 320 may additionally be added at other edges of individual cells of the low-voltage storage, such as at one or more sides (C in FIG. 3B), or at a top portion (B in FIG. 3B), which may give rise to additional capabilities for heat dissipation. In particular embodiments, placement of the additional potting material 320 may be selected so as not to interfere with locations of terminals (+ or −) of the SSB prismatic cell stack 200 that, as illustrated in FIG. 3B, are adjacent to the top portion B. In particular embodiments, such as those involving energy storage cells that do not incorporate liquid electrolytes, use of a potting material may not be needed to prevent leakage of electrolyte material into a potting material, which could negatively impact properties of a potting material.

FIG. 4A is a schematic diagram illustrating an application of stack pressure to storage cells such as first cell 310 and second cell 315 of a SSB prismatic cell stack 200. As shown in FIG. 4A (embodiment 400), for relatively low stack pressure 425, width 405 (w₁) between adjacent energy storage cells 310 and 315 includes a first value.

However, as is shown in FIG. 4B (embodiment 450), for increased stack pressure 426, width 410 (w₂) is shown as decreased in relation to width 405. It may be appreciated that a compliant material between adjacent energy storage cells 310 and 315 may facilitate such decreases in width as stack pressure increases from a nominal value to an increased value. In particular embodiments, as a charge state of an individual energy storage cell and/or sub-cell fluctuates, the face of the energy storage cell and/or sub-cell may be displaced by for example, by as little as about 5.0 percent or by as much as about 25.0 percent.

FIGS. 4C (embodiment 475) and 4D (embodiment 490) are schematic diagrams of an example SSB prismatic cell stack 200 including a compliant material 485 disposed between adjacent storage cells of the SSB prismatic cell stack 200 during a low SOC in FIG. 4C and during a high SOC in FIG. 4D, according to one or more embodiments. For example, as seen in embodiment 475 (FIG. 4C), a SSB prismatic cell stack 200 corresponding to a relatively low SOC (e.g., less than 10 percent charge) may bring about minimum expansion of individual storage cells. Accordingly, responsive to such minimal expansion of individual storage cells, compliant material 485 may expand so as to occupy gaps or spaces between adjacent individual storage cells. Accordingly, despite minimal expansion of individual storage cells, which may result from low states of charge of individual storage cells, compliant material 485 may operate to sufficiently maintain stack pressure within SSB prismatic cell stack 200.

Embodiment 490 (FIG. 4D) depicts the SSB prismatic cell stack 200 during a relatively high SOC, such as greater than 50 percent, 75 percent, or even 100 percent, depending on an implementation, particular application, battery system operation, vehicle, etc. In such instances, individual storage cells of SSB prismatic cell stack 200 may expand, in which such expansion operates to reduce spacing between adjacent individual storage cells. In such instances, compliant material 485 may be reduced in volume.

In some embodiments, one or more cells of 310 and 315 of FIG. 3A and/or sub-cells may be coupled with a terminal connection between the cells for the positive electrode and negative electrode current collectors. Negative current collectors may be connected or coupled to a negative terminal connection and the positive current collectors may be connected or coupled to a positive terminal connection. For example, the positive terminal connection may couple the positive current collectors of cells 310 and 315, and the negative terminal connection may couple the negative current collectors of cells 310 and 315. Both negative and positive terminal connections may be connected or coupled to an element on the substantially rigid casing 220. In another embodiment, the SSB prismatic cell stack 200 may also be configured with a tab-less negative electrode. For example, the SSB prismatic cell stack 200 in the substantially rigid casing 220 may also be designed with tab-less negative electrode where the negative electrode current collectors are bonded to the casing 220 and the negative terminal connection is also connected or coupled to the casing 220.

In particular embodiments, a casing such as substantially rigid casing 220 may be formed from material that is electrochemically compatible with cells of a prismatic cell stack, so as not to introduce galvanic action, which may degrade metallic interfaces between individual cells and the casing and individual cells. In some instances, such direct coupling between individual cells and a substantially rigid casing may provide a more efficient low-voltage storage device.

It may be appreciated that various embodiments may provide a benefit of membranes that are sized for ease of manufacturability, high-yield, rapid scale-up and simpler approaches toward application of stack pressure to cells and/or sub-cells. Further, particular embodiments may operate to minimize overhead for pressure adsorption. Particular embodiments may utilize an essentially hard-case prismatic design with a thicker or more substantial fill housing and a small amount of permanent elastic filler, to provide cooling and expansion management via compliant material either behind the plates or between sub-cells, cells, and/or cell stacks of one or more SSB prismatic cell stack(s) 200. It should be noted that compliant material could include materials that include at least a substantial portion of polyurethane, such as polyurethane foam, or may include other comparable materials.

With respect to embodiment 475 (in FIGS. 4C and 4D), the energy storage system 105 may include one or more SSB prismatic cell stacks configured according to the present invention. For example, the SSB prismatic cell stacks 200 may be configured to produce a “super cell”, in SSB cells may be coupled in parallel or in series.

FIG. 5 is a schematic diagram showing a battery management system interfaced to a number of energy storage system 105 that may include high-voltage and/or low-voltage energy storage (e.g., 110, 115), according to an embodiment 500. In particular embodiments, battery management system 120 may additionally be coupled to one or more high-voltage storage elements (110) such as a SSB prismatic cell stack 200 depending on the nominal voltage and claim subject matter is not limited in this respect. In the embodiment of FIG. 5, battery management system 120 may operate to determine the electrical parameters of energy storage elements. In addition, battery management system 120 may operate to balance the voltage of, and/or current conduction from, high-voltage storage 110, low-voltage storage 115, or the like. For example, responsive to battery management system 120 detecting higher internal resistance of a particular energy storage system 105, system 120 may permit the particular energy source to be charged to a higher state-of-charge, thereby facilitating or ensuring that the particular energy storage system 105 is capable of supplying an expected current amount and/or delivering such current at an expected voltage level.

FIG. 6 is a schematic block diagram illustrating an example computing system environment, according to an embodiment 600. One or more of the computing system components identified in FIG. 6 may be utilized, for example, by battery management system 120, which may operate to measure the impedance presented by a series or parallel arrangement of energy storage cells of a an energy storage system 105 that may include a low-voltage storage 115 and high-voltage storage 110, such as the solid-state prismatic cell stack 200. In addition, responsive to detection of an increase in impedance presented by one or more energy storage cells (such as beyond a threshold impedance), the battery management system 120 may permit a state-of-charge of one or more energy storage cells to be increased (such as beyond a threshold impedance). By way of such an increase in the state-of-charge of one or more energy cells, the battery management system 120 may permit the one or more energy cells and/or sub-cells to increase in volume, thereby increasing stack pressure applied to, for example, all energy storage cells and/or sub-cells of the energy storage system 105. Via an increase in stack pressure, or at least maintaining minimal stack pressure, (e.g., by increasing a state-of-charge of energy storage cells of a SSB prismatic cell stack 200) a battery management system 120 may compensate for aging of energy storage cells. Such compensation may enhance the usable life of energy storage devices (of energy storage system 105), for example, of electrified vehicle 102.

In FIG. 6, first device 602, which may correspond to a logic element within an energy storage system 105, may provide one or more sources of executable computer instructions in the form of physical states and/or signals (e.g., stored in memory states), for example. First device 602 and third device 606, which may correspond to an additional second energy storage system 105, may communicate with second device 604, which may correspond to a battery management system 120, by way of a network connection, such as via network 608, for example. First device 602 and computing device 604 may communicate with additional components of energy storage system 105, such as third device 606, which may correspond to such a second energy storage system, or to a different logic element of energy storage system 105. As previously mentioned, a connection, while physical, may be virtual while not necessarily being tangible. Although computing device 604 of FIG. 6 shows various tangible, physical components, claimed subject matter is not limited to a computing devices having only these tangible components as other implementations and/or embodiments may include alternative arrangements that may include additional tangible components or fewer tangible components, for example, that function differently while achieving similar results. Rather, examples are provided merely as illustrations. It is not intended that claimed subject matter be limited in scope to illustrative examples.

Memory 622 may include any non-transitory storage mechanism. Memory 622 may include, for example, primary memory 625 and secondary memory 626, additional memory circuits, mechanisms, or combinations thereof may be used. Memory 622 may include, for example, random access memory, read only memory, etc., such as in the form of one or more storage devices and/or systems, such as, for example, a disk drive including an optical disc drive, a tape drive, a solid-state memory drive, etc., just to name a few examples.

Memory 622 may include one or more articles utilized to store a program of executable computer instructions. For example, processor 620 may fetch executable instructions from a primary memory 625 and/or secondary memory 626 via the bus 615 and proceed to execute the fetched instructions. Memory 622 may also include a memory controller for accessing device readable-medium 640 that may carry and/or make accessible digital content, which may include code, and/or instructions, for example, executable by processor 620 and/or some other device, such as a controller, as one example, capable of executing computer instructions, for example. Under direction of processor 620, a non-transitory memory, such as memory cells storing physical states (e.g., memory states), including, for example, a program of executable computer instructions, may be executed by processor 620 and able to generate signals to be communicated via a network 608 to the first device 602 and/or the third device 606, for example, as previously described. The processor 620 may also communicate via the bus 615 with a communication interface 630 and input/output module 632. Generated signals may also be stored in memory, also previously suggested.

Memory 622 may store electronic files and/or electronic documents, such as relating to one or more users, and may also include a machine-readable medium that may carry and/or make accessible content, including code and/or instructions, for example, executable by processor 620 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted that an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the setting or environment of the present patent application, and generally, is considered to be a self-consistent sequence of operations and/or similar signal processing leading to a desired result. In the setting or environment of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

Processor 620 may include one or more circuits, such as digital circuits, to perform at least a portion of a computing procedure and/or process. By way of example, but not limitation, processor 620 may include one or more processors, such as controllers, micro-processors, micro-controllers, application specific integrated circuits, digital signal processors, programmable logic devices, field programmable gate arrays, the like, or any combination thereof. In various implementations and/or embodiments, processor 620 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 6 also illustrates device 604 as including module 632 operable with input/output devices, and communication bus 615, for example, so that signals and/or states may be appropriately communicated between devices, such as device 604 and an input device and/or device 604 and an output device. A user may make use of an input device, such as a computer mouse, stylus, track ball, keyboard, and/or any other similar device capable of receiving user actions and/or motions as input signals. Likewise, for a device having speech to text capability, a user may speak to generate input signals. Likewise, a user may make use of an output device, such as a display, a printer, etc., and/or any other device capable of providing signals and/or generating stimuli for a user, such as visual stimuli, audio stimuli and/or other similar stimuli.

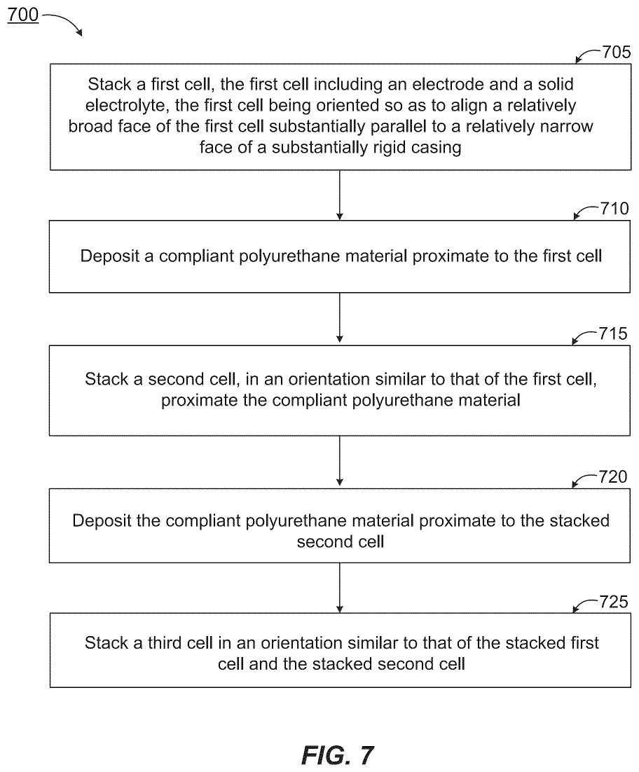

FIG. 7 is a flow chart showing method steps to manufacture a SSB prismatic cell stack, according to an embodiment 700. It should be noted that claimed subject matter is intended to embrace all of the actions depicted at 705-725, fewer actions than those depicted at 705-725, and/or more actions than those depicted at 705-725. Further, claimed subject matter is intended to embrace some or all of the actions depicted at 705-725 in an order different than that depicted in FIG. 7. The method of FIG. 7 may begin at 705, which may include stacking a first cell, in which the first cell includes an electrode and a solid electrolyte, the first cell being oriented so as to align a relatively broad face of the first cell substantially parallel to a relatively narrow side of a substantially rigid casing. The method may continue at 710, which may include depositing a compliant material, such as a material that includes at least a substantial percentage of polyurethane, proximate to the stacked first cell. In particular embodiments, the compliant polyurethane material may include at least a substantial percentage of a polyurethane foam. The method may continue at 715, which may include stacking a second cell, in an orientation similar to that of the stacked first cell, proximate the compliant polyurethane material. In an embodiment, first and second cells may be stacked in an orientation such that a relatively broad face of the first and second cells face a relatively narrow side of a prismatic-shaped casing. The method may continue at 720, which may include depositing the compliant polyurethane material proximate to the second stacked cell. The method may continue at 725, which may include stacking a third cell in an orientation similar to that of the stacked first cell and the stacked second cell.

In particular embodiments, in addition to those actions illustrated in FIG. 7, a method may additionally include depositing a potting material (e.g., potting material 320 shown in FIG. 3A) at a first inside surface (e.g., the bottom surface) of a substantially rigid casing. The method may additionally include positioning the SSB prismatic cell stack inside the substantially rigid casing, wherein the SSB prismatic cell stack is proximate with the potting material. The method may additionally include depositing a polymer-based gap filler (e.g., polymer-based gap filler 360 shown in FIG. 3A) at a second inside surface and a third inside surface of the substantially rigid casing. The method may additionally include depositing an elastic filler in the substantially rigid casing, in which the SSB prismatic cell stack is coupled to the elastic filler. In particular embodiments, the method may also include configuring a positive terminal connection and a negative terminal connection for the SSB prismatic cell stack, in which the positive terminal connection is to couple positive current collectors for the first cell, the second cell, and the third cell in addition, the negative terminal connection is to couple negative current collectors for the first cell, the second cell, and the third cell.

In the context of the present disclosure, the term “connection,” the term “component” and/or similar terms are intended to be physical, but are not necessarily always tangible. Whether or not these terms refer to tangible subject matter, thus, may vary in a particular circumstance of usage. As an example, a tangible connection and/or tangible connection path may be made, such as by a tangible, electrical connection, such as an electrically conductive path including metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular circumstance of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular circumstance of usage, such as the particular circumstances in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the setting or environment of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in particular circumstances of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular circumstance of usage, such as in which tangible materials and/or tangible components are discussed, between being “beneath” and being “under.” While “beneath,” in such circumstances of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict the scope of claimed subject matter. For example, the term “over,” as an example, is not meant to suggest that claim scope is limited to only situations in which an embodiment is right side up, such as in comparison with the embodiment being upside down, for example. Of course, again, as always has been the case in the specification of a patent application, particular circumstances of description and/or usage provides helpful guidance regarding reasonable inferences to be drawn.

Unless otherwise indicated, in the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall with the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively include a sum of at least two components. Thus, for a given measurement, for example, one component may include a deterministic component, which in an ideal sense, may include a physical value (e.g., sought via one or more measurements), often in the form of one or more signals, signal samples and/or states, and one component may include a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve the use of more complex techniques. In this regard, as alluded to above, one or more measurements of physical manifestations may be modeled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to the use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular circumstances of the description and/or usage provides helpful guidance regarding reasonable inferences to be drawn.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1.-14. (canceled)

15. A method for forming an energy storage system, comprising:
forming a cell stack by performing:
stacking a first cell, the first cell comprising an electrode and a solid electrolyte, the first cell being oriented so as to align a face of the first cell parallel to an end plate of a substantially rigid casing;
depositing a compliant polyurethane material proximate to the stacked first cell;
stacking a second cell, in an orientation similar to that of the stacked first cell, proximate the compliant polyurethane material;
depositing the compliant polyurethane material proximate to the stacked second cell; and
stacking a third cell in an orientation similar to that of the stacked first cell and the stacked second cell, and
depositing a potting material at a bottom inside surface of the substantially rigid casing;
positioning the cell stack inside the substantially rigid casing, wherein the cell stack is proximate with the potting material and sides of the first, second, and third cells abut inner surfaces of walls of the substantially rigid casing;
depositing a polymer-based gap filler to inside surfaces of end plates of the substantially rigid casing; and
placing additional potting material proximate to the cell stack adjacent to a top cover of the substantially rigid casing, and selectively between terminal connections without interfering with locations of the terminal connections, that are configured across top surfaces of the cell stack and the compliant material, and the potting material is used as a thermal interface for heat dissipation for cells of the cell stack.

16. The method of claim 15, wherein the compliant material is disposed to accommodate an increase of up to 20 percent displacement of a surface of faces of the cells, and/or the compliant polyurethane material comprises at least a percentage of polyurethane foam.

17. The method of claim 15, further comprising:
depositing an elastic filler, in the substantially rigid casing and coupled to the cell stack, to provide cooling and expansion management via the compliant material either behind the end plates or between cells in the cell stack.

18. The method of claim 15, wherein:
the additional potting material is placed between the top cover of the substantially rigid casing and the cell stack.

19. (canceled)

20. The method of claim 15, wherein:
the terminal connections include a positive terminal connection and a negative terminal connection for the cell stack,
the positive terminal connection is to couple positive current collectors for the first cell, the second cell, and the third cell, and
the negative terminal connection is to couple negative current collectors for the first cell, the second cell, and the third cell.

21. The method according to claim 15, wherein the substantially rigid casing is to maintain a stack pressure on the plurality of cells of between 0.4 Megapascals and 4.5 Megapascals.

22. The method of claim 15, further comprising:
coupling a storage cell management system to the cell stack to compute impedance of at least one of the first, second, and third cells; and in response to an increase in a computed impedance, initiate operation of the at least one of the first, second, and third cells at an increased state-of-charge.

23. The method of claim 22, wherein the storage cell management system is configured to operate responsive to aging of the first, second, and third cells.

24. The method of claim 22, wherein the storage cell management system is to initiate operation of at least one of the first, second, and third cells at an increased state-of-charge to maintain a stack pressure on the first, second, and third cells of between 0.4 Megapascals and 4.5 Megapascals.

25. The method according to claim 15, wherein the substantially rigid casing comprises a wall thickness dimension of between 0.3 millimeter and 1.0 millimeter.

26. The method according to claim 15, wherein the substantially rigid casing comprises a width dimension of between 15 millimeters and 175 millimeters.

27. The method according to claim 15, wherein the substantially rigid casing comprises a length dimension of the first side that is between 1.5 times and 10 times the width dimension of the substantially rigid casing.

28. The method according to claim 15, wherein the substantially rigid casing comprises a length dimension that is between 1.5 times and 10 times a height dimension of the substantially rigid casing.

29. The method according to claim 15, wherein the substantially rigid casing comprises the height dimension of between 40 millimeters and 160 millimeters.

30. The method according to claim 15, wherein the cell stack comprises a shape that corresponds to that of a right rectangular prism.
